(19) United States
(12) Patent Application Publication
(10) Pub. No.: US 2024/0269874 A1
(43) Pub. Date: Aug. 15, 2024

(54) SHEATH ASSEMBLY

(71) Applicant: Outdoor Element, LLC, Englewood, CO (US)

(72) Inventor: Michael John Mojica, Englewood, CO (US)

(73) Assignee: Outdoor Element, LLC, Englewood, CO (US)

(21) Appl. No.: 18/441,276

(22) Filed: Feb. 14, 2024

Related U.S. Application Data
(60) Provisional application No. 63/484,885, filed on Feb. 14, 2023.

(51) Int. Cl. B26B 29/02; F23Q 1/06

(52) U.S. Cl. CPC B26B 29/025; F23Q 1/06

(57) ABSTRACT

The disclosed technology includes a knife sheath with a removable rod. The knife sheath is configured to generate sparks to ignite fire when the rod is scraped with a knife. In some embodiments, the knife sheath includes a mounting provision configured to couple with a first end of the removable rod via corresponding threaded features. In some embodiments, the knife sheath is part of a knife assembly.

### CROSS-REFERENCE TO RELATED APPLICATIONS

This application claims priority of U.S. Provisional Patent Application No. 63/484,885, entitled “Knife Assembly,” filed Feb. 14, 2023, which is hereby incorporated by reference in its entirety.

### TECHNICAL FIELD

The present application relates generally to a sheath assembly, and a knife assembly, including a rod-shaped sparking element fastened to a sheath of a knife.

### BACKGROUND

The outdoors are enjoyed by many people. A knife and having the ability to start a fire can be critical for enjoyment and survival in the outdoors. Ferrocerium alloy was invented in the early 1900's and has been used for decades as a means to create fire. The primary components of ferrocerium are iron and the rare-earth element cerium. Over the years, other elements such as magnesium, praseodymium, and neodymium have been added to enhance the fire-starting ability. When struck with a harder material, the ferrocerium mixture produces hot sparks that can reach temperatures exceeding 3,000 degrees Celsius. These hot sparks can easily ignite tinder and thus start a fire. Common commercial applications for ferrocerium include ignition source of lighters, and strikers for gas welding torches. Ferrocerium's ability to ignite in adverse conditions have proven extremely useful and therefore ferrocerium rods are commonly used in emergency and survival kits. In the outdoors, a knife can be used to help prepare and cook food. A knife can be used to gut a fish or other game and process vegetables, for first aid, to help defend against wildlife predators, and help for building a shelter. A knife can be an essential tool to have while in the outdoors. Having a combination of these two instruments can prove invaluable in times of outdoor emergencies.

### BRIEF SUMMARY

An embodiment of the present invention relates to a sheath with threaded provisions to mount a rod made with materials intended to ignite and start fires. The rod is threaded and is removable from the knife sheath.

Another embodiment of the present invention relates to a fix or knife assembly including a handle, a blade, a knife with a portion of the knife constructed with a hard edge, and a sheath with threaded provisions to mount a removable rod made with materials intended to ignite and start fires.

### BRIEF DESCRIPTION OF DRAWINGS

The accompanying drawings, which are included to provide a further understanding of the embodiment and are incorporated in and constitute a part of this specification, illustrate embodiments of the disclosed device and together with the detailed description serve to explain the principles of the embodiment. In the drawings:

FIG. 1 is a perspective view of an example knife assembly in accordance with embodiments of the present disclosure.

FIG. 2 is a front view of an example knife assembly in accordance with embodiments of the present disclosure.

FIG. 3 is a bottom view of an example knife assembly in accordance with embodiments of the present disclosure.

FIG. 4 is a side view an example knife assembly in accordance with embodiments of the present disclosure.

FIG. 5 is a perspective view of an example sheath with a rod in accordance with embodiments of the present disclosure.

FIG. 6 is an exploded perspective view of an example sheath in accordance with embodiments of the present disclosure.

FIG. 7 is an exploded perspective view of an example sheath in accordance with embodiments of the present disclosure.

FIG. 8 is a front view of an example knife assembly in accordance with embodiments of the present disclosure.

FIG. 9 is a front view of an example knife assembly in accordance with embodiments of the present disclosure.

FIG. 10 is a perspective view of an example knife assembly in accordance with embodiments of the present disclosure.

FIG. 11 is a perspective view of an example knife assembly in accordance with embodiments of the present disclosure.

FIG. 12 is a perspective view of an example knife assembly in accordance with embodiments of the present disclosure.

FIG. 13 is a perspective view of an example knife assembly in accordance with embodiments of the present disclosure.

FIG. 14 is a perspective view of an example knife assembly in accordance with embodiments of the present disclosure.

FIG. 15 is a perspective view of an example sheath and rod in accordance with embodiments of the present disclosure.

FIG. 16 is a perspective view of an example knife assembly in accordance with embodiments of the present disclosure.

FIG. 17 is a front view of an example knife assembly in accordance with embodiments of the present disclosure.

FIG. 18 is a perspective view of an example knife assembly in accordance with embodiments of the present disclosure.

FIG. 19 is a perspective view of an example knife assembly in accordance with embodiments of the present disclosure.

### DETAILED DESCRIPTION

Embodiments are discussed in detail below. In describing embodiments, specific terminology is employed for the sake of clarity. However, the various embodiments are not intended to be limited to the specific terminology so selected. A person skilled in the relevant art would recognize that other equivalent parts can be employed, and other methods developed without departing from the spirit and scope of the disclosure. All references cited herein are incorporated by references as if each had been individually incorporated.

The disclosed technology includes embodiments of a sheath with a removable rod and a knife assembly that includes a knife and a sheath with a removable rod. The removable rod may be stored in a mounting provision on the sheath. The removable rod may be removed from the mounting provision during use, and used to start fires.

In some embodiments, the sheath with the removable rod is configured to be used with a knife. In other embodiments, the sheath with the removable rod is configured to be used with a different kind of tool or apparatus.

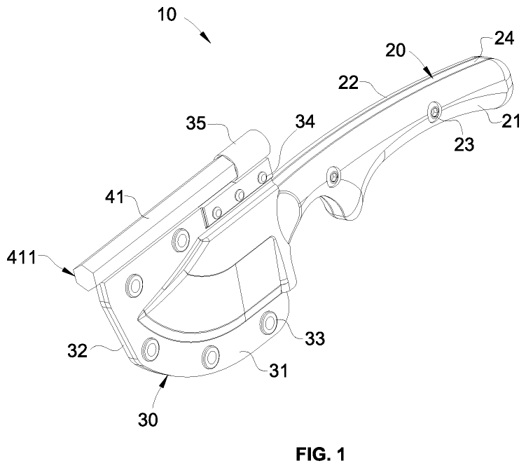

FIG. 1 shows a perspective view of a knife assembly 10 with a handle 20, and a blade inside a sheath 30. The knife sheath 30 has a mounting provision 35 that is threaded to couple a rod 41 made with materials, such as ferrocerium, magnesium, praseodymium, and neodymium, intended to ignite and start fires. The rod 41 is threaded and is removable from the sheath 30. The rod is constructed with a hex shape 411. This shape is designed to aid in removable and installation of the rod 41 with the mounting provision 35. This hex shape 411 is not limited to a hexagonal form and may be constructed in many different forms including but not limited to a square, pentagon, or triangular shape. The handle 20 in the embodiment is designed to be grasped by the user of the knife 10. The handle 20 may be molded as a single body (e.g., injection molded from a polymer, such as polyoxymethylene). According to the current embodiment of FIG. 1, the handle 20 may include a pair of handles 21 and 22 made of various materials such as but not limited to polymers, metals, or combinations thereof that are coupled together with fasteners 23 such as screws. In another embodiment, the handle 20 may be one continuous material as the blade or the handle 20 may be wrapped in another material such a paracord. The knife may be constructed in many different forms including but not limited to a fixed or non-folding knife, or a folding knife with a variety of blade profiles such as but not limited to drop-point, sheepsfoot, clip-point, tanto, and so forth. According to the current embodiment of FIG. 1 the sheath 30 is constructed with two sides 31 and 32 that are coupled together with rivets 33 and 34. In this current embodiment rivets 34 combine both the sides 31 and 32 and the mounting provision 35 together. The sheath 30 may made of various materials and may be constructed with many parts and other features such as but not limited to a knife sharpener, clip, whistle, and so forth. The sheath 30 may also be constructed of a single part such as a plastic mold injected component with a threaded insert that acts a mounting provision for the rod 41.

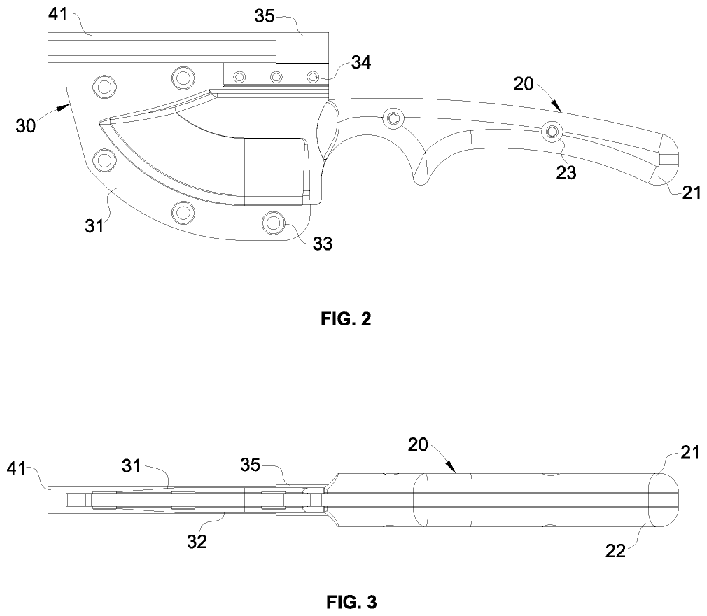

FIG. 2 illustrates a front view of the knife of FIG. 1. In this embodiment the blade of the knife is fully seated in the sheath. The rod 41 has a section of length that extends past the end of the sheath 30. This extended portion allows for closed shaped tools such as a closed-end wrench to engage with the rod 41 for assembly or disassembly. The rod 41 may be equal distant or shorter thus not extending past the sheath 30. In an embodiment where the rod 41 does not extend past the sheath 30 an open-faced tool maybe used to tighten or loosen the rod 41 from the mounting provision 35.

FIG. 3 illustrates a third angle orthogonal bottom projection view of FIG. 2. The handle 20 is designed for a grip in the user's hand.

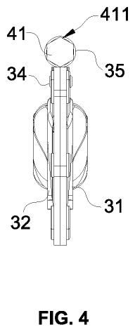

FIG. 4 illustrates a side view of the knife of FIG. 2 according to an embodiment of the disclosure. The hex shape 411 is clearly illustrated in this view. A tool may be placed over this profile to allow coupling of the rod 41 to the tool. The tool may be used to rotate the rod 41. This rotation will allow the rod 41 to engage or disengage from mounting provision 35 allowing.

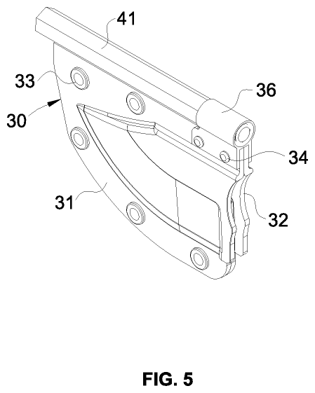

FIG. 5 illustrates a perspective view of a sheath 30 with a threaded mounting provision 36. In the current embodiment of FIG. 5 the mounting provision 36 uses two rivets 34 to be coupled to the sheath 30. There are a plurality of methods, techniques, and fasteners that may be used to couple a mounting provision 36 to the sheath. For instance, a mounting provision may be directly inserted into a plastic mold injected sheath and use no other fasteners to couple the mounting provision to the sheath. In this embodiment, the mounting provision 36 is designed with a set of U-channel legs that slides over both sides of the sheath 31 and 32. A mounting provision could have a single flange or leg that is sandwiched between the sheath. In another embodiment, the rivets 34 may be substituted with other components (e.g., screws and nuts, barrel fasteners, etc.).

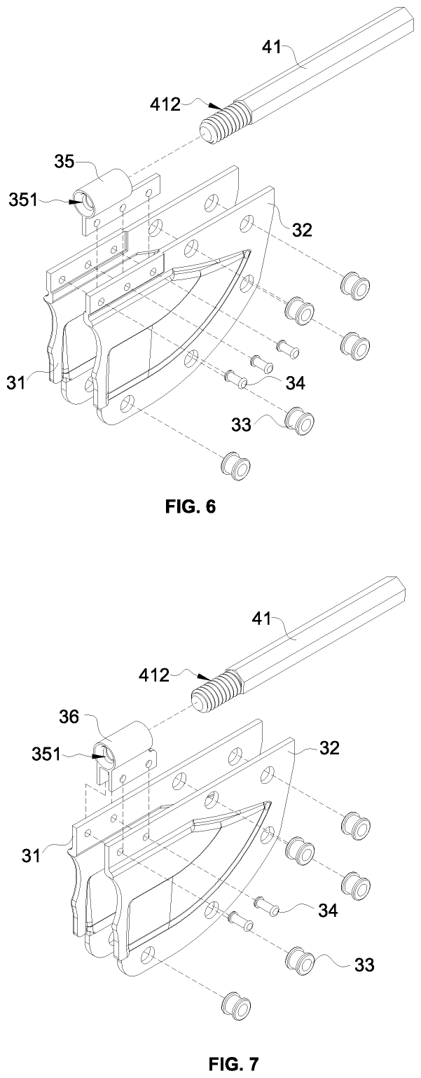

FIG. 6 illustrates an exploded perspective view of a sheath 30 according to an exemplary embodiment of the disclosure. The rod 41 is constructed with an externally threaded end 412. The mounting provision 35 has mating internal threads 351 that allow the rod 41 to be coupled to the mounting provision 35. For example, if the threaded end 351 of the rod 41 was a ¼-20″ UNC external threads, then the mounting provision 35 would have a corresponding ¼″-20 UNC internal thread feature. The threaded sections of both components, the rod 41 and the mounting provision 35 may have metric or imperial threads. The threads may be fine or coarse. In this exemplary embodiment of the disclosure the mounting provision 35 has a single leg or flange is that captured in between the sheath sides 31 and 32. Rivets 34 are used to couple the mounting provision 35 with the two sheath sides 31 and 32.

FIG. 7 illustrates an exploded perspective view of FIG. 5. Serving as another embodiment of the mounting provision 36 that couples with the sheath sides 31 and 32. This embodiment illustrates two legs extending downward that mate with corresponding holes pattern through which rivets 34 or fasteners couple the mounting provision 36 and sheath sides 31 and 32 together. The rod 41 and the mounting provision 36 have corresponding male and female thread types for proper engagement and coupling.

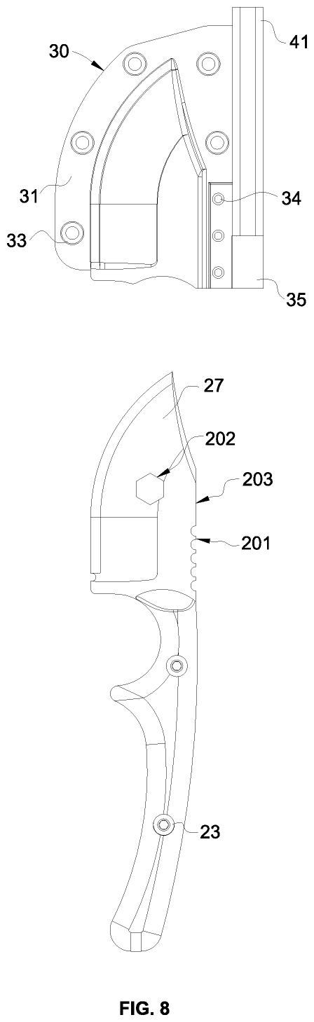

FIG. 8 illustrates a front view of FIG. 1 with the sheath 30 separated from the knife blade body 27 according to an embodiment of the disclosure. In this exemplary embodiment the knife is designed with a section of the external profile with an abrupt edge that is not deburred or rounded over. This hard edge 203 can be used to scrape the rod to generate sparks. A square 90-degree edge is an optimal change of geometry for the hard edge 203. In the current embodiment the hard edge 203 is located on the spine of the knife body 27. In other embodiments, this hard edge 203 may be located in various locations of the knife external profile. A hard square edge 203 is ideal and effective for producing sparks from the ferrocerium rod. The hard edge 203 can be formed along a non-linear section of the knife body 27. For example, the external front profile on the handle section may be formed in an arc, while the side face of the arc maintains a hard edge relative to the front face.

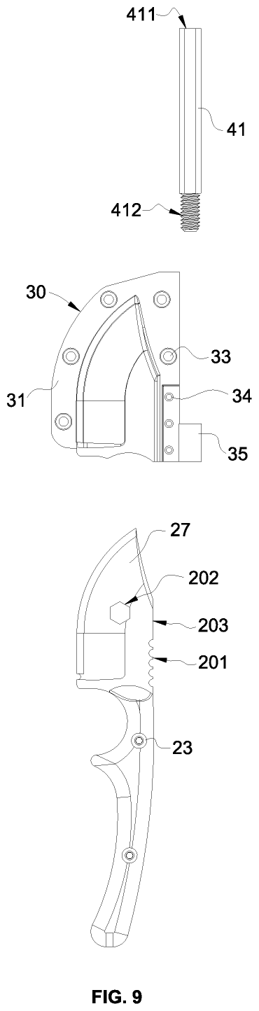

FIG. 9 illustrates a front view of FIG. 1 with the sheath 30 separated from the knife blade body 27 and the sparking rod 41 separated from the sheath according to an embodiment of the disclosure. The rod 41 has at least two sections, one end being a threaded section 412 and the other section being formed in a shape that is favorable for a tool to engage the rod 41 to generate rotation for the purpose of engaging or disassembly of the rod 41 and the mounting provision 35. In the current embodiment the knife body 27 may have a feature tool shape 202 that corresponds to the rod hex shape 411 so that the knife may be used as a tool to remove or install the rod 41 to the mounting provision 35.

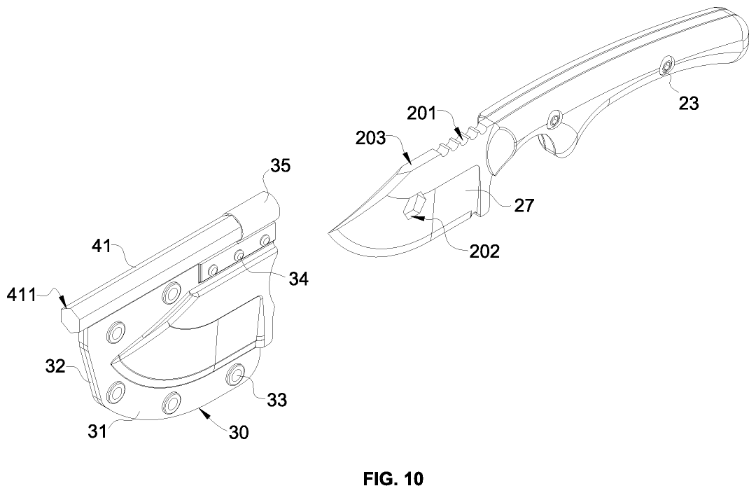

FIG. 10 illustrates a perspective view of FIG. 1 with the sheath separated from the knife blade body 27 according to an embodiment of the disclosure. The knife may have repeating ridges or grooves 201 on the top of the spine to provide better grip as the knife is used. In other embodiments this grove section may be wider, shorter, or not present on the spine. If the grooves 201 are not present, this may give more area for the hard edge 203 to be placed on the spine to engage with the rod 41. The sheath 30 is intended to protect the blade from unintended engagement of external objects or bodies while not in use. In other embodiments the sheath may have other features for safety such as a strap that is attached to the sheath and that wraps around the heel or bolster of the blade to prevent unintentional disengagement from the sheath.

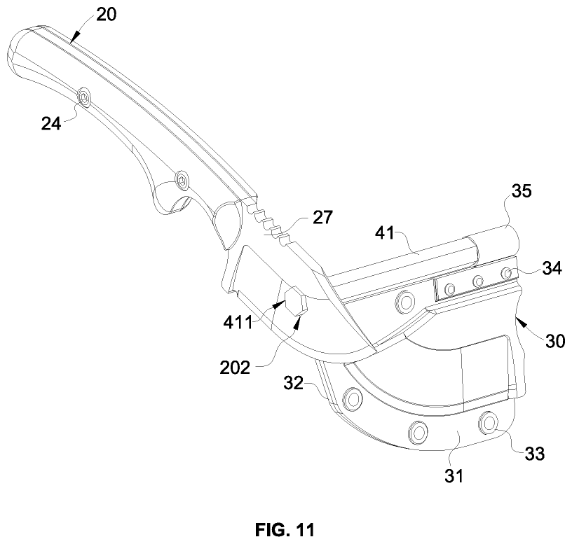

FIG. 11 illustrates a perspective view of FIG. 1 with the sheath 30 internal pocket separated from the knife body 27 according to an embodiment of the disclosure. The knife shape tool feature 202 may engage with the rod hex shape 411. The knife handle 20 may be used as a lever arm to create a turning force, otherwise known as a moment of a force, to generate a rotational movement to engage or disengage the threaded sections of the rod 41 and the mounting provision 35.

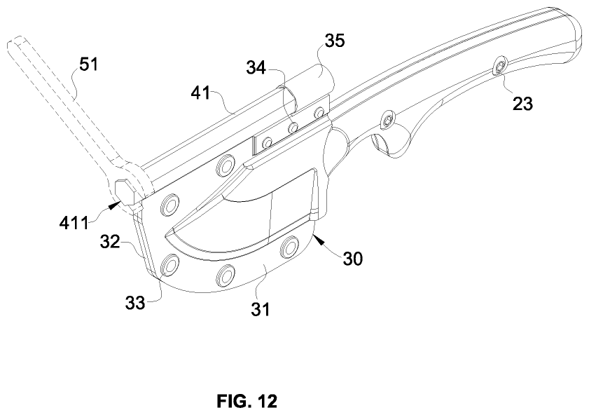

FIG. 12 illustrates a perspective view of FIG. 1 with a tool 51 engaged with the rod 41 according to an embodiment of the disclosure. In the current embodiment the tool 51 is engaged at the rod 41 end. However, the tool 51 may engage the rod 41 at the end or in the middle section.

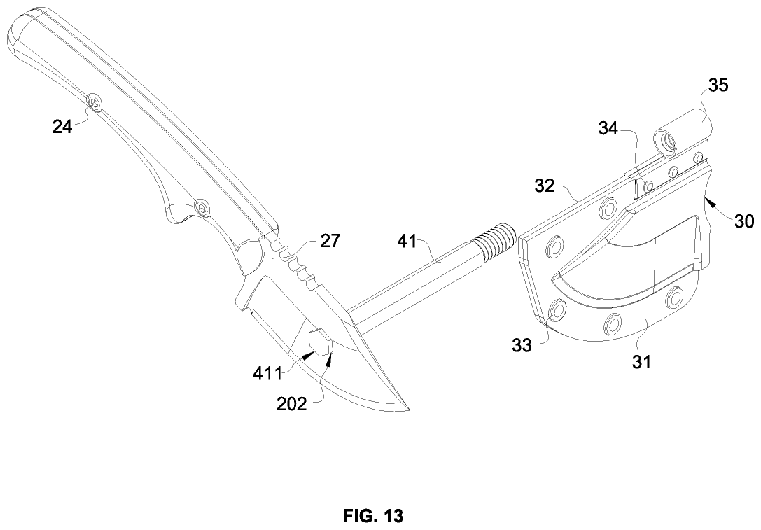

FIG. 13 illustrates a perspective view of FIG. 1 with the sheath 30 separated from the knife body 27, with the knife shape tool feature 202 engaged with the rod hex shape 411. The rod 41 is separated from the sheath according to an embodiment of the disclosure. The knife acts as a tool allowing engagement of the rod 41 to the mounting provision 35.

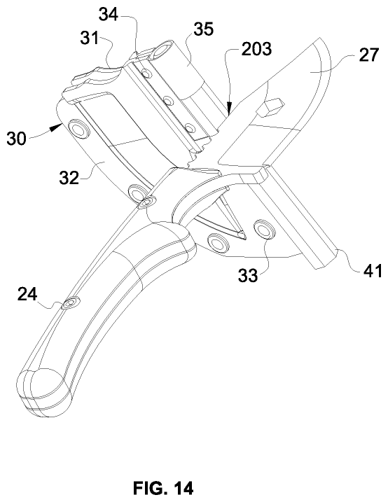

FIG. 14 illustrates a perspective view of FIG. 1 with a knife's spine hard edge 203 pressing against the rod 41 that is fastened to the sheath 30 in an embodiment of the disclosure. In this embodiment, the spine of the knife body 27 contains a hard edge 203 feature. In another embodiment the hard edge may be located in another section of the knife body. When the hard edge 203 is pressed against and scraped down the length of the rod 40, the result yields hot sparks that can be used to start a fire.

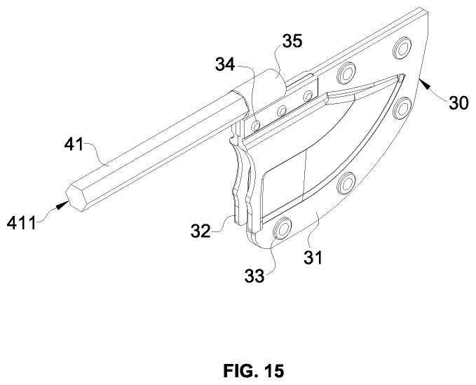

FIG. 15 illustrates a perspective view of FIG. 6 with the rod 41 mounted in the opposite direction relative to FIG. 5 according to an embodiment of the disclosure. The mounting provision 35 may have a through threaded section. In this embodiment, the rod 41 may be assembled to either side of the mounting provision 35. In this current arrangement of FIG. 15 the user may have more area to grasp the sheath 30 providing more room for the rod 41 to be scraped to produce sparks.

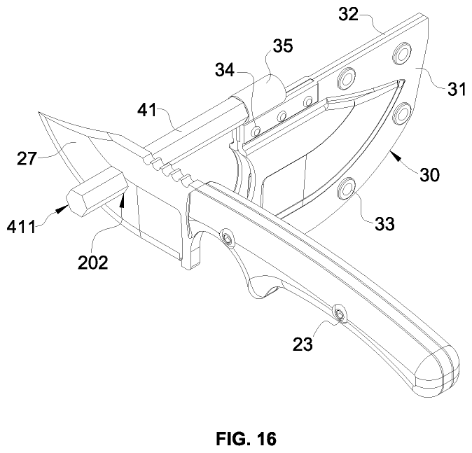

FIG. 16 illustrates a perspective view of FIG. 1 with the rod 41 mounted in the same direction as FIG. 15, and the knife tool feature 202 section is engaged with the rod hex shape 411 according to an embodiment of the disclosure. The knife may be used as a tool to disengage or engage the rod 41 to the mounting provision 35 from either side of the sheath.

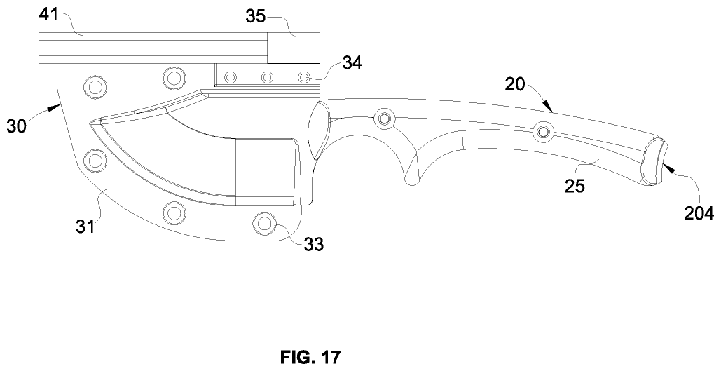

FIG. 17 illustrates a front view of another embodiment according to the disclosure with hard edge 204 in a non-linear configuration. The handle side 25 is configured shorter than the blade body end allowing the hard edge to be used for the rod 41. In this embodiment, the external front profile on the end pf the blade body 27 handle section is formed in an arc, while the side face of the arc maintains a hard edge relative to the front face.

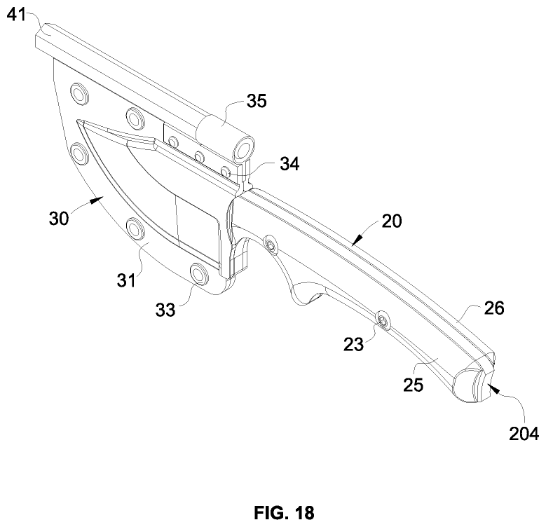

FIG. 18 illustrates a perspective view of FIG. 17 according to another embodiment of the disclosure. This view illustrates both handles 25 & 26 shorter in length of the blade body handle hard edge 204 section.

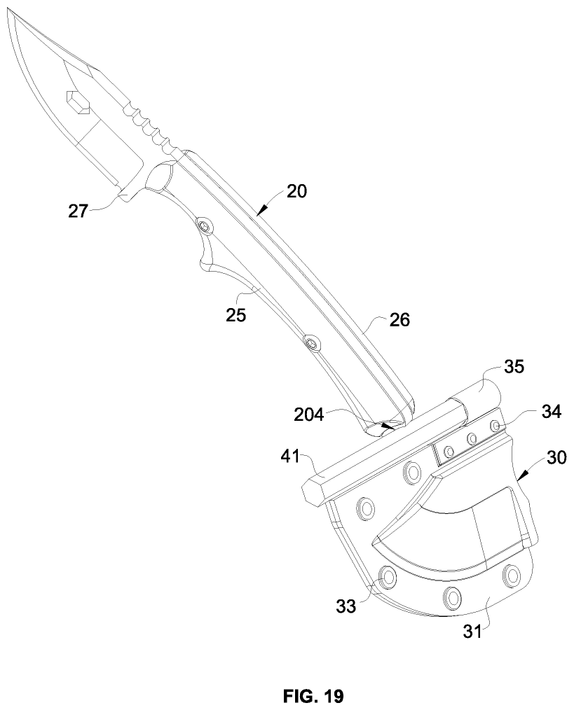

FIG. 19 is a perspective view of FIG. 17 with the blade body 27 handle 20 end engaged with the rod according to an embodiment of the disclosure. When the end of the handle 20 curved, hard edge 204 section is pressed against the rod 41 and scraped along the length of the rod 41, it generates sparks to ignite a fire. The hard edge may be located in any section of the knife body 27 profile. This hard-edge feature may be linear or non-linear.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. For example, it will be understood that embodiments of the invention may be made from a variety of different materials.

What is claimed is:

1. A sheath, including:
a removable rod configured to generate sparks to ignite fire when scraped on a hard surface; and
a mounting provision configured to receive the removable rod.

2. The sheath of claim 1, wherein the mounting provision is configured to couple with a first end of the removable rod via corresponding threaded features.

3. The sheath of claim 1, wherein the removable rod includes at least two sections, wherein a first section is threaded for coupling with the mounting provision, and a second section is non-threaded.

4. The sheath of claim 2, wherein the second section is configured for a tool to attach to the second section and rotate the removable rod.

5. The sheath of claim 3, wherein the second section is shaped in a shape corresponding to a shape of an aperture in the tool.

6. The sheath of claim 4, wherein the second section is hexagonal-shaped and a corresponding aperture in the tool is hexagonal-shaped.

7. The sheath of claim 1, wherein the removable rod includes a sparking element.

8. The sheath of claim 1, wherein the hard surface is a knife.

9. The sheath of claim 1, wherein the sheath is configured to receive and store a knife.

10. The sheath of claim 1, wherein the removable rod is made with at least one of ferrocerium, magnesium, praseodymium, and neodymium.
